(19) United States
(12) Patent Application Publication
(10) Pub. No.: US 2026/0164183 A1
(43) Pub. Date: Jun. 11, 2026

(54) ACOUSTIC SYSTEM

(71) Applicant: ALPS ALPINE CO., LTD., Tokyo (JP)

(72) Inventors: Ryo ITO, Fukushima (JP); Yuji SAITO, Fukushima (JP); Hiroki TOITA, Fukushima (JP)

(21) Appl. No.: 19/183,304

(22) Filed: Apr. 18, 2025

(30) Foreign Application Priority Data
May 2, 2024 (JP) 2024-074676

(51) Int. Cl. H04R 9/04

(52) U.S. Cl. CPC H04R 9/04

(57) ABSTRACT

To provide “acoustic system” for obtaining required drive force with low power, first voice coil greater in height dimension than gap in which magnetic flux propagates and second voice coil equal in height dimension to gap are provided such that their height-direction centers coincide. When amplification factors of audio signal applied to first and second voice coils are defined as A1 and A2, respectively, A1 is set to 0 and A2 is set to A2st when detected displacement of loudspeaker is within displacement range where second voice coil is at position where it can properly interact with magnetic flux in gap. A2 is set to 0 and A1 is set to A1st when detected displacement is within range where A2 is not set to A2st. A2st is smaller than A1st. Ranges where second voice coil is offset from gap are included in displacement ranges where A1 is set to A1st.

### CROSS-REFERENCE TO RELATED APPLICATION

The present application claims priority under 35 U.S.C. §119 to Japanese Patent Application No. 2024-074676, filed May 2, 2024, the contents of which are incorporated herein by reference in their entireties.

### BACKGROUND OF THE INVENTION

### FIELD OF THE INVENTION

The present disclosure relates to a technique for driving a loudspeaker.

### DESCRIPTION OF THE RELATED ART

A technique known to be related to the present application provides a loudspeaker with a sensor for detecting a displacement of a vibration system of the loudspeaker, wherein based on a response, in the form of the displacement, to an input signal, the technique corrects the input signal such that distortion in an output from the loudspeaker will be reduced, and outputs the corrected input signal to the loudspeaker (for example, Japanese Patent Application Laid-Open Publication No. 2007-81815).

Another technique known to be related to the present application provides a loudspeaker with a plurality of voice coils having different Direct-Current (DC) resistance values, wherein the voice coils to be driven are switchable such that the Q factor of the loudspeaker at low frequencies can be varied (for example, Japanese Utility Model Application Laid-Open Publication No. S62-139192).

### SUMMARY OF THE INVENTION

Consider a case of inhibiting occurrence of operation failures of a loudspeaker, such as occurrence of an output distortion, occurrence of an over-amplitude, and the like, by maneuvering a signal to be applied to the voice coils based on a displacement of a vibration system of the loudspeaker detected by a sensor. In this case, a displacement that offsets the voice coils from a gap that is located between a top plate and a center pole and in which a magnetic flux propagates might spoil a drive force that may act on the voice coils, because a drive force acts on the voice coils through interaction of the voice coils with the magnetic flux in the gap. Therefore, such a displacement makes it impossible to inhibit occurrence of operation failures.

On the other hand, setting the height (i.e., the length in the axial direction of the loudspeaker) of the voice coils to be sufficiently greater than the height of the gap, which does make it possible to inhibit the voice coils from being displaced to a position that is offset from the gap, in turn makes a drive force that acts on the voice coils in response to the same input lower than a drive force that acts on voice coils that have approximately the same height as the height of the gap. This worsens the initial sensitivity and the like. On the other hand, amplifying a signal to be output to the voice coils at a high amplification factor can increase a drive force that acts on the voice coils, but this increases the power to be consumed.

Accordingly, an object of the present disclosure is to obtain a required drive force on the voice coils while restricting power consumption as much as possible.

To achieve the object, the present disclosure provides an acoustic system including a loudspeaker, a processor configured to drive the loudspeaker with an audio signal, and a sensor configured to detect a displacement of a vibration system of the loudspeaker in an axial direction of the loudspeaker. The loudspeaker includes a first voice coil and a second voice coil that, when viewed in a radial direction of the loudspeaker, are situated in a gap in which a magnetic flux propagates in the radial direction. A size of a range of the first voice coil in the axial direction of the loudspeaker is greater than a size of a range of the gap in the axial direction, a size of a range of the second voice coil in the axial direction is less than the size of the range of the first voice coil in the axial direction, and the range of the second voice coil in the axial direction falls within the range of the first voice coil in the axial direction. The processor functions as: a first driver configured to apply an audio signal amplified at a first amplification factor, which is set, to the first voice coil; and a second driver configured to apply an audio signal amplified at a second amplification factor, which is set, to the second voice coil. The processor sets 0 as the second amplification factor and sets a first standard amplification factor, which is a predetermined amplification factor, as the first amplification factor when a position of the second voice coil in the axial direction represented by the displacement detected by the sensor is within a non-interactive range in which the second voice coil is unable to interact with the magnetic flux propagating in the gap, and sets 0 as the first amplification factor and sets a second standard amplification factor, which is a predetermined amplification factor, as the second amplification factor when the position of the second voice coil is within an interactive range in which the second voice coil is able to interact properly with the magnetic flux propagating in the gap.

In this acoustic system, the non-interactive range may be a range in which the position of the second voice coil is outside the range of the gap in the axial direction, and the interactive range may be a range in which the position of the second voice coil is not outside the range of the gap in the axial direction.

The acoustic system may be configured such that midpoints of the ranges of the gap, the first voice coil, and the second voice coil in the axial direction are equal in the axial direction in a state in which no audio signal is applied to both the first voice coil and the second voice coil.

In the acoustic system, the first standard amplification factor is higher than the second standard amplification factor, the first driver includes a first amplifier configured to output an audio signal to be applied to the first voice coil, the second driver includes a second amplifier configured to output an audio signal to be applied to the second voice coil, and a power source voltage of the second amplifier may be lower than a power source voltage of the first amplifier.

Alternatively, in the acoustic system described above, setting of the amplification factors may be performed by, when the position of the second voice coil in the axial direction represented by the displacement detected by the sensor is at a position at which the second voice coil is unable to interact with the magnetic flux propagating in the gap, setting an amplification factor that is smaller than when the position is at a position at which the second voice coil is able to interact with the magnetic flux, as the second amplification factor, and setting an amplification factor that is greater than when the position is at a position at which the second voice coil is able to interact with the magnetic flux, as the first amplification factor.

The processor of the acoustic system may maneuver the audio signal for driving the first voice coil such that the loudspeaker is excluded from causing an operation failure, based on the displacement detected by the sensor.

The acoustic system described above includes the first voice coil of which the range in the axial direction has a size greater than that of the gap, and the second voice coil of which the range in the axial direction has a size smaller than that of the first voice coil. Typically when the second voice coil is located within a range in which the second voice coil is able to properly interact with the magnetic flux propagating in the gap, the acoustic system drives the loudspeaker by applying an audio signal only to the second voice coil. When the second voice coil is located within a range in which the second voice coil is unable to interact with the magnetic flux propagating in the gap, the acoustic system drives the loudspeaker by applying an audio signal only to the first voice coil.

Here, when the second voice coil is able to properly interact with the magnetic flux propagating in the gap, a drive force in response to the same input acts more greatly on the second voice coil having a smaller range in the axial direction than on the first voice coil. Therefore, the amplification factor of an audio signal in a case of driving the loudspeaker by applying the audio signal only to the second voice coil may be smaller than the amplification factor of the audio signal in a case of driving the loudspeaker by applying the audio signal only to the first voice coil. As a result, it is possible to make the power consumption in a case of applying the audio signal only to the second voice coil lower than the power consumption in a case of applying the audio signal only to the first voice coil.

Moreover, even when the second voice coil becomes offset from the gap and the second voice coil becomes unable to interact with the magnetic flux propagating in the gap, the first voice coil having a greater range in the axial direction than that of the second voice coil is in a state of being able to interact with the magnetic flux propagating in the gap. Therefore, by driving the first voice coil, it is possible to obtain a drive force required for an operation for properly reproducing the audio signal, an operation for inhibiting operation failures, and the like.

As described above, according to the present disclosure, it is possible to obtain a required drive force for driving the voice coils while restricting power consumption as much as possible.

### BRIEF DESCRIPTION OF THE DRAWINGS

FIG. 1 is a diagram showing the configuration of an acoustic system according to an embodiment of the present disclosure;

FIG. 2 is a diagram showing the configuration of a loudspeaker according to an embodiment of the present disclosure; and

FIG. 3 is a diagram showing an example of controlling an amplification factor according to an embodiment of the present disclosure.

### DETAILED DESCRIPTION OF THE DISCLOSURE

An embodiment of the present disclosure will be described below.

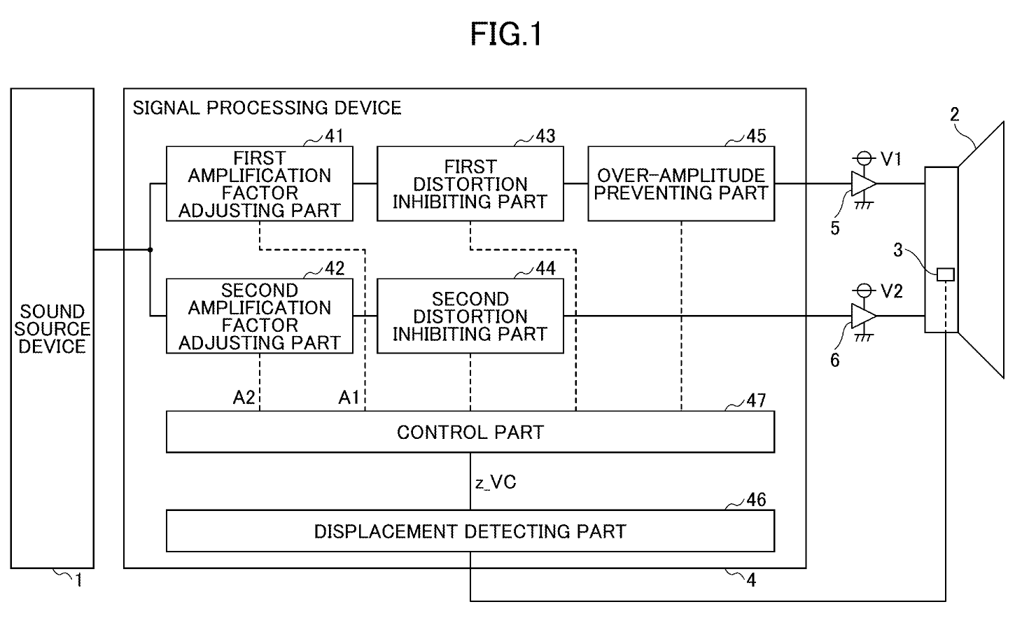

FIG. 1 shows the configuration of an acoustic system according to the present embodiment.

As shown in the drawing, the acoustic system includes a sound source device 1 for outputting audio signals, a loudspeaker 2, a displacement sensor 3 provided in the loudspeaker 2, a signal processing device 4, a first amplifier 5, and a second amplifier 6.

A power source voltage V1 of the first amplifier 5 is higher than a power source voltage V2 of the second amplifier 6, and the rated output/output maximum amplitude of the first amplifier 5 is higher than the rated output/output maximum amplitude of the second amplifier 6.

Here, when the acoustic system is one that is mounted on an automobile, an automobile battery can be used as the power source for the second amplifier 6, and the power source voltage V2 is approximately from 12 V to 13 V. When an automobile battery is used as the power source for the second amplifier 6, the power source voltage of the battery is boosted to, for example, 20 V and used as the power source voltage V1.

The signal processing device 4 can be configured using, for example, a Digital Signal Processor (DSP), and includes a first amplification factor adjusting part 41, a second amplification factor adjusting part 42, a first distortion inhibiting part 43, a second distortion inhibiting part 44, an over-amplitude preventing part 45, a displacement detecting part 46, and a control part 47.

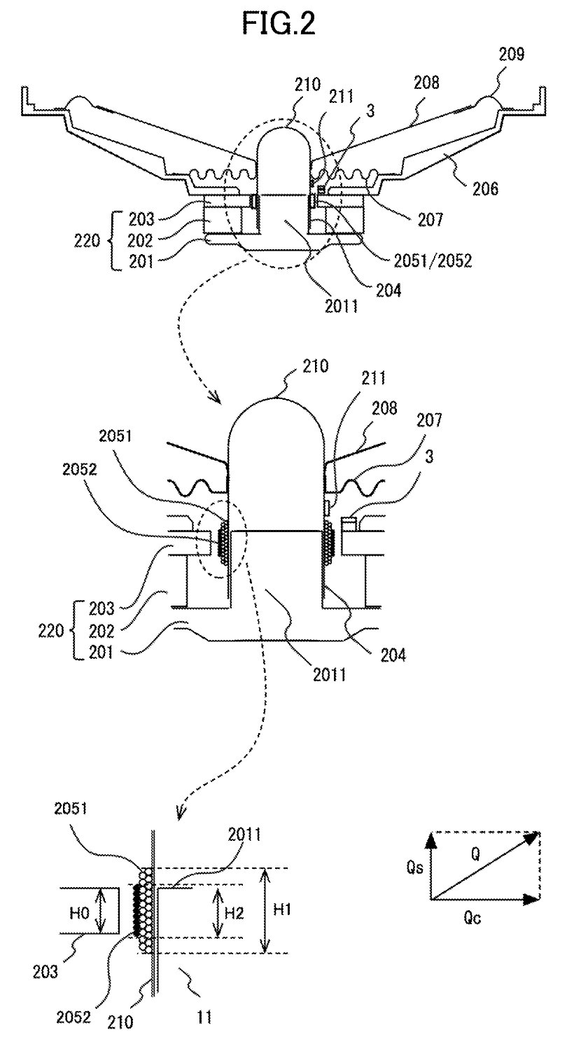

The upper view of FIG. 2 shows the configuration of the loudspeaker 2.

As shown, the loudspeaker 2 includes a yoke 201, a magnet 202, a top plate 203, a voice coil bobbin 204, voice coils 205, a frame 206, a damper 207, a diaphragm 208, an edge 209, a dust cap 210, and a displacement detecting magnet 211.

When the direction to the upper side in the drawing in the axial direction of the loudspeaker 2 is defined as the upward direction of the loudspeaker 2, and the direction to the lower side is defined as the downward direction of the loudspeaker 2. The yoke 201 includes a center pole 2011 projecting upward in the center. The magnet 202 having an annular shape is provided on the outer circumference of the center pole 2011, and the top plate 203 having an annular shape is provided on the magnet 202. The top plate 203 is composed of a conductive member, such as iron and the like. The yoke 201, the magnet 202, and the top plate 203 form a magnetic circuit 220.

Here, as shown in the upper view and the middle view of FIG. 2, the voice coil bobbin 204 has a hollow cylindrical shape. As shown in the middle view and the lower left view of FIG. 2, a first voice coil 2051 of which the coil wire is represented by whit circles, and a second voice coil 2052 of which the coil wire is represented by black circles are wound on the outer circumference of the voice coil bobbin 204 in a state in which the second voice coil 2052 is stacked on the outer circumference of the first voice coil 2051.

The center pole 2011 of the yoke 201 is inserted into the hollow of the voice coil bobbin 204 from thereunder, such that the voice coil bobbin 204 can move upward and downward relative to the yoke 201.

As shown in the middle view and the lower left view of FIG. 2, in a neutral state in which no signal is applied to the first voice coil 2051 and the second voice coil 2052, the first voice coil 2051 and the second voice coil 2052 are located such that the positions of the centers of the first voice coil 2051 and the second voice coil 2052 in the upward/downward direction (i.e., the axial direction of the loudspeaker 2) coincide with the position of the upward/downward direction center of a gap, which is a clearance between the center pole 2011 of the yoke 201 and the top plate 203 through which a magnetic flux propagates in the radial direction (i.e., the leftward/rightward direction in the drawing) of the loudspeaker 2.

As shown in the lower left view of FIG. 2, the height (i.e., the length in the upward/downward direction) H1 of the first voice coil 2051 is significantly greater than the height H0 of the gap (for example, H1≥1.5×H0), and the height H2 of the second voice coil 2052 is substantially equal to the height H0 of the gap.

Therefore, when matching impedance of the first voice coil 2051 with that of the second voice coil 2052, the first voice coil 2051 has a larger wire diameter and a longer wire length than those of the second voice coil 2052.

The diaphragm 208 has a shape that is the same as or similar to the side surface of a truncated cone of which the height direction is substantially the upward/downward direction of the loudspeaker 2, and the outer peripheral end of the diaphragm 208 is connected to the upper end of the frame 206 by the edge 209. The inner peripheral end of the diaphragm 208 is fixed to the upper end of the voice coil bobbin 204.

In this configuration of the loudspeaker 2, when a signal is applied to the first voice coil 2051 and the second voice coil 2052, the voice coil bobbin 204 vibrates upward and downward in accordance with the amplitude of the applied signal through the electromagnetic action between the magnetic flux passing in the gap in the radial direction and the signal flowing through the first voice coil 2051 and the second voice coil 2052 to which the signal is applied. When the voice coil bobbin 204 vibrates, the diaphragm 208 connected to the voice coil bobbin 204 vibrates, to generate a sound corresponding to the applied signal.

Next, as shown in the upper view and the middle view of FIG. 2, the displacement detecting magnet 211 is fixed on the outer circumferential side of the voice coil bobbin 204 so as to move upward and downward together with the voice coil bobbin 204, and generates a magnetic flux in a direction orthogonal to the magnetic flux generated by the magnetic circuit 220.

The aforementioned displacement sensor 3 is fixed to a position, on a non-vibration system of the loudspeaker 2, such as the top plate 203 or the like, the position being close to the displacement detecting magnet 211. The displacement sensor 3 is a magnetic angle sensor, and as shown in the lower right drawing of FIG. 2, the displacement sensor 3 detects and outputs the arctangent Qs/Qc of the angle of a resultant vector Q of a magnetic flux vector Qc acting from the magnetic circuit 220 and a magnetic flux vector Qs acting from the displacement detecting magnet 211 as a magnetic angle. Since the magnetic flux vector generated by the displacement detecting magnet 211 to act on the displacement sensor 3 changes depending on the displacement of the displacement detecting magnet 211 accompanying the displacement of the voice coil bobbin 204 in the upward/downward direction, the magnetic angle becomes a value that is in accordance with the amount of a displacement of the voice coil bobbin 204 in the upward/downward direction, and therefore, with the position of the vibration system of the loudspeaker 2 in the upward/downward direction.

Returning to FIG. 1, the displacement detecting part 46 of the signal processing device 4 calculates a displacement position z_VC of the vibration system of the loudspeaker 2 in the upward/downward direction based on the magnetic angle detected by the displacement sensor 3, and outputs it to the control part 47.

The control part 47 controls the amplification factor A1 of the first amplification factor adjusting part 41 in accordance with the displacement position z_VC of the vibration system of the loudspeaker 2 detected by the displacement detecting part 46, and controls the amplification factor A2 of the second amplification factor adjusting part 42 in accordance with the displacement position z_VC.

In addition, the control part 47 predicts occurrence of an over-amplitude of the vibration system of the loudspeaker 2 based on the displacement position z_VC of the vibration system of the loudspeaker 2 detected by the displacement detecting part 46, the amplitude of the vibration of the vibration system of the loudspeaker 2 indicated by the displacement position z_VC, and the like. When occurrence of an over-amplitude is predicted, the control part 47 controls execution of an over-amplitude preventing operation of the over-amplitude preventing part 45. Here, an over-amplitude of the vibration system of the loudspeaker 2 means an amplitude having a magnitude at which mechanical failures occur, such as bottoming, which is a collision of the voice coil bobbin 204 with the yoke 201, and the like.

The control part 47 relays the displacement position z_VC of the vibration system of the loudspeaker 2 detected by the displacement detecting part 46 to the first distortion inhibiting part 43, the second distortion inhibiting part 44, and the over-amplitude preventing part 45.

Next, the first amplification factor adjusting part 41 amplifies an audio signal input from the sound source device 1 at the amplification factor A1 set by the control part 47 and outputs the amplified audio signal to the first distortion inhibiting part 43. Note that, when the amplification factor A1 is 0, the first amplification factor adjusting part 41 may realize the amplification at the amplification factor A1 in the form of an output of 0.

The first distortion inhibiting part 43 applies a transfer function set in itself to the audio signal input from the first amplification factor adjusting part 41 and outputs the result to the over-amplitude preventing part 45. Furthermore, the first distortion inhibiting part 43 performs an operation for updating the transfer function set in itself to a transfer function for correcting the audio signal such that a response, in the form of the displacement position z_VC notified from the control part 47, to the audio signal input from the first amplification factor adjusting part 41 becomes a response including no distortion. Note that, when the amplification factor A1 is 0, the first distortion inhibiting part 43 may perform an operation of outputting 0 as an output.

Normally, the over-amplitude preventing part 45 outputs the audio signal input from the first distortion inhibiting part 43 to the first amplifier 5 transparently, as-is. However, during a period in which execution of the over-amplitude preventing operation is controlled by the control part 47, the over-amplitude preventing part 45 performs the following over-amplitude preventing operation. That is, as the over-amplitude preventing operation, the over-amplitude preventing part 45 performs a braking operation for generating a braking signal that gives the first voice coil 2051 a drive force in a direction opposite to the displacement direction indicated by the displacement position z_VC notified from the control part 47, and outputting the braking signal to the first amplifier 5 instead of the audio signal. Alternatively, as the over-amplitude preventing operation, the over-amplitude preventing part 45 performs, for example, an amplitude restricting operation for attenuating the audio signal input from the first distortion inhibiting part 43 and outputting it to the first amplifier 5.

The first amplifier 5 amplifies the audio signal or the braking signal input from the over-amplitude preventing part 45 at an amplification factor that is preset fixedly, and outputs the amplified signal to the first voice coil 2051 of the loudspeaker 2.

Next, the second amplification factor adjusting part 42 amplifies the audio signal input from the sound source device 1 at the amplification factor A2 set by the control part 47 and outputs it to the second distortion inhibiting part 44. Note that, when the amplification factor A2 is 0, the second amplification factor adjusting part 42 may realize the amplification at the amplification factor A2 in the form of an output of 0.

The second distortion inhibiting part 44 applies a transfer function set in itself to the audio signal input from the second amplification factor adjusting part 42 and outputs the result to the second amplifier 6. Further, the second distortion inhibiting part 44 updates the transfer function to a transfer function for correcting the audio signal such that a response, in the form of the displacement position z_VC notified from the control part 47, to the audio signal input from the second amplification factor adjusting part 42 becomes a response including no distortion. Note that, when the amplification factor A2 is 0, the second distortion inhibiting part 44 may perform an operation of outputting 0 as an output.

The second amplifier 6 amplifies the audio signal input from the second distortion inhibiting part 44 at the same amplification factor as that of the first amplifier 5 and outputs it to the second voice coil 2052 of the loudspeaker 2.

Hereinafter, the control performed by the control part 47 on the amplification factor A1 of the first amplification factor adjusting part 41 and the amplification factor A2 of the second amplification factor adjusting part 42 in accordance with the displacement position z_VC of the vibration system of the loudspeaker 2 will be described.

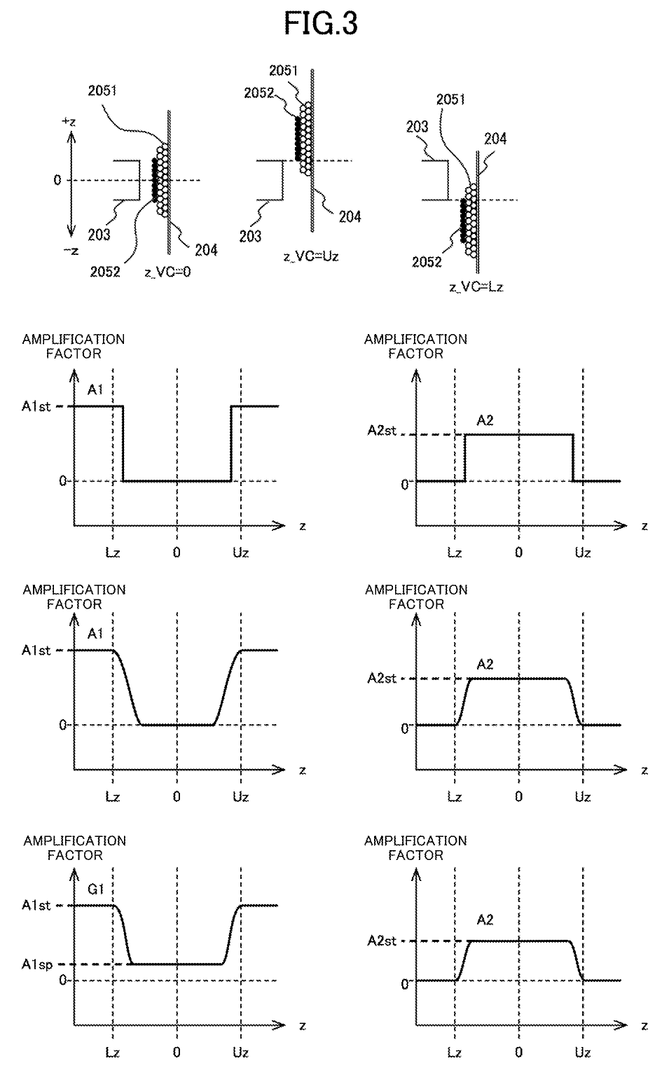

Here, based on the premise that the displacement position z_VC is represented using a coordinate axis z extending in the upward/downward direction of the loudspeaker 2 as shown in the uppermost left view of FIG. 3, it is assumed that z_VC takes a value of 0 (z_VC=0) when the center positions of the first voice coil 2051 and the second voice coil 2052 in the upward/downward direction coincide with the center position of the gap in the height direction (upward/downward direction), that z_VC takes a value of Uz>0 (z_VC=Uz>0) when the voice coil bobbin is displaced upward from the position shown in the uppermost left view of FIG. 3 and the lower end of the second voice coil 2052 reaches the upper end of the gap as shown in the uppermost center view of FIG. 3, and that z_VC takes a value of Lz<0 (z_VC=Lz<0) when the voice coil bobbin is displaced downward from the position shown in the uppermost left view of FIG. 3 and the upper end of the second voice coil 2052 reaches the lower end of the gap as shown in the uppermost right view of FIG. 3. The control part 47 controls the amplification factor A1 of the first amplification factor adjusting part 41 and the amplification factor A2 of the second amplification factor adjusting part 42 as shown in, for example, the second uppermost left and right graphs of FIG. 3.

That is, in a range, within the range represented by Uz≥z_VC≥Lz, in which the second voice coil 2052 is at a position at which the second voice coil 2052 is able to interact properly with the magnetic flux in the gap, the amplification factor A1 is set to 0, and the amplification factor A2 is set to a predetermined amplification factor A2st. In a range in which the amplification factor A2 is not set to the amplification factor A2st, the amplification factor A2 is set to 0, and the amplification factor A1 is set to a predetermined amplification factor A1st. Here, the range in which the amplification factor A1 is set to the amplification factor A1st includes a range represented by z_VC<Lz and a range represented by z_VC>Uz in both of which the second voice coil 2052 is at a position that is offset from the gap. The range in which the second voice coil 2052 is at a position at which the second voice coil 2052 is able to interact properly with the magnetic flux in the gap may be the range represented by Uz≥z_VC≥Lz in which the second voice coil 2052 is not completely offset from the gap.

Here, A1st is an amplification factor that can realize a drive force required for a required vibration when only the first voice coil 2051 is driven with an audio signal amplified by A1st, and A2st is an amplification factor that can realize a drive force required for a required vibration when only the second voice coil 2052 is driven with an audio signal amplified by A2st. When a proper interaction with the magnetic flux in the gap is secured, a drive force in response to the same input acts more greatly on the second voice coil 2052, which has a smaller height, than on the first voice coil 2051. Therefore, as illustrated, there is a relationship of 0<A2st<A1st.

Therefore, the amplitude of an audio signal to be output from the second amplifier 6 and the power to be consumed by the second amplifier 6 when driving only the second voice coil 2052 by supplying the audio signal amplified by A2st to the second amplifier 6 are smaller than the amplitude of an audio signal to be output from the first amplifier 5 and the power to be consumed by the first amplifier 5 when driving only the first voice coil 2051 by supplying the audio signal amplified by A1st to the first amplifier 5. Moreover, the power to be consumed by the first amplifier 5 when the amplification factor A1 is set to 0 and the power to be consumed by the second amplifier 6 when the amplification factor A2 is set to 0 are sufficiently small because the outputs from the first amplifier 5 and the second amplifier 6 are also 0.

Therefore, such a control on the amplification factor A1 of the first amplification factor adjusting part 41 and the amplification factor A2 of the second amplification factor adjusting part 42 makes it possible to restrict the power to be consumed by the first amplifier 5 and the second amplifier 6 when driving only the second voice coil 2052 to be lower than the power to be consumed by the first amplifier 5 and the second amplifier 6 when driving only the first voice coil 2051, and to secure a drive force required for a required vibration also when driving only the first voice coil 2051.

Moreover, since the second amplifier 6 of which the power source voltage (rated output/output maximum voltage) is lower than that of the first amplifier 5 used for driving the first voice coil 2051 is used for driving the second voice coil 2052, also from this viewpoint, it is possible to restrict the power to be consumed when driving only the second voice coil 2052 to be low.

Moreover, even when the second voice coil 2052 becomes offset from the gap and the second voice coil 2052 is unable to interact with the magnetic flux propagating in the gap, the first voice coil 2051 having a broader range in the axial direction than that of the second voice coil 2052 is in a state of being able to interact with the magnetic flux propagating in the gap. Therefore, it is possible to obtain a drive force, for driving the first voice coil 2051, that is necessary for a proper operation for reproducing an audio signal and an operation for inhibiting operation failures.

When controlling the amplification factor A1 of the first amplification factor adjusting part 41 and the amplification factor A2 of the second amplification factor adjusting part 42 as shown in the second uppermost left and right graphs of FIG. 3, the control part 47 controls the operation of the first distortion inhibiting part 43 and the second distortion inhibiting part 44 such that the first distortion inhibiting part 43 updates the transfer function set in itself only during a period in which the amplification factor A2 is 0, and the second distortion inhibiting part 44 updates the transfer function set in itself only during a period in which the amplification factor A1 is 0.

Here, the control on the amplification factor A1 of the first amplification factor adjusting part 41 and the amplification factor A2 on the second amplification factor adjusting part 42 may be performed as shown in the second lowermost left and right graphs of FIG. 3.

The control shown in the second lowermost left and right graphs of FIG. 3 is for causing the change of the amplification factor A1 between 0 and A1st and the change of the amplification factor A2 between 0 and A2st in the control shown in the second uppermost left and right graphs of FIG. 3 to occur gradually.

Also when controlling the amplification factor A1 of the first amplification factor adjusting part 41 and the amplification factor A2 of the second amplification factor adjusting part 42 as shown in the second lowermost left and right graphs of FIG. 3, the control part 47 controls the operation of the first distortion inhibiting part 43 and the second distortion inhibiting part 44 such that the first distortion inhibiting part 43 updates the transfer function set in itself only during a period in which the amplification factor A2 is 0, and the second distortion inhibiting part 44 updates the transfer function set in itself only during a period in which the amplification factor A1 is 0.

Here, the control on the amplification factor A1 of the first amplification factor adjusting part 41 and the amplification factor A2 of the second amplification factor adjusting part 42 may be performed as shown in the lowermost left and right graphs of FIG. 3.

The control shown in the lowermost left and right graphs of FIG. 3 is for adjusting the value A2st of the amplification factor A2 to be lower than that of the second lowermost right graph of FIG. 3 and for adjusting the amplification factor A1 to a value A1sp during a period in which the amplification factor A2 is A2st in the control shown in the second lowermost left and right graphs of FIG. 3. There is a relationship of A1st>A1sp>0, and A1sp is an amplification factor that can realize a drive force on the vibration system required for a required vibration when driving the second voice coil 2052 at the amplification factor A2st and driving the first voice coil 2051 at the amplification factor A1sp.

Note that, when controlling the amplification factor A1 of the first amplification factor adjusting part 41 and the amplification factor A2 of the second amplification factor adjusting part 42 as shown in the lowermost left and right views of FIG. 3, the control part 47 controls the first distortion inhibiting part 43 such that the first distortion inhibiting part 43 updates the transfer function set in itself only during a period in which the amplification factor A2 is 0. In this case, updating of the transfer function of the second distortion inhibiting part 44 is not performed, and a predetermined transfer function is fixedly used as the transfer function of the second distortion inhibiting part 44. Alternatively, an audio signal may be directly output from the second amplification factor adjusting part 42 to the second amplifier 6 without the second distortion inhibiting part 44 being provided.

What is claimed is:

1. An acoustic system, comprising:
a loudspeaker;
a processor configured to drive the loudspeaker with an audio signal; and
a sensor configured to detect a displacement of a vibration system of the loudspeaker in an axial direction of the loudspeaker,
wherein the loudspeaker includes a first voice coil and a second voice coil that, when viewed in a radial direction of the loudspeaker, are situated in a gap in which a magnetic flux propagates in the radial direction,
wherein a size of a range of the first voice coil in the axial direction of the loudspeaker is greater than a size of a range of the gap in the axial direction, and a size of a range of the second voice coil in the axial direction is less than the size of the range of the first voice coil in the axial direction,
wherein the range of the second voice coil in the axial direction falls within the range of the first voice coil in the axial direction, and
wherein the processor functions as:
a first driver configured to apply an audio signal amplified at a first amplification factor, which is set, to the first voice coil;
a second driver configured to apply an audio signal amplified at a second amplification factor, which is set, to the second voice coil, and
wherein the processor: sets 0 as the second amplification factor and sets a first standard amplification factor, which is a predetermined amplification factor, as the first amplification factor when a position of the second voice coil in the axial direction represented by the displacement detected by the sensor is within a non-interactive range in which the second voice coil is unable to interact with the magnetic flux propagating in the gap; and sets 0 as the first amplification factor and sets a second standard amplification factor, which is a predetermined amplification factor, as the second amplification factor when the position of the second voice coil is within an interactive range in which the second voice coil is able to properly interact with the magnetic flux propagating in the gap.

2. The acoustic system according to claim 1,
wherein the non-interactive range is a range in which the position of the second voice coil is outside the range of the gap in the axial direction, and the interactive range is a range in which the position of the second voice coil is not outside the range of the gap in the axial direction.

3. The acoustic system according to claim 1,
wherein in a state in which no audio signal is applied to both the first voice coil and the second voice coil, midpoints of the ranges of the gap, the first voice coil, and the second voice coil in the axial direction are equal in the axial direction.

4. The acoustic system according to claim 1,
wherein the first standard amplification factor is higher than the second standard amplification factor,
wherein the first driver includes a first amplifier configured to output an audio signal to be applied to the first voice coil,
wherein the second driver includes a second amplifier configured to output an audio signal to be applied to the second voice coil, and
wherein a power source voltage of the second amplifier is lower than a power source voltage of the first amplifier.

5. An acoustic system, comprising:
a loudspeaker;
a processor configured to drive the loudspeaker with an audio signal; and
a sensor configured to detect a displacement of a vibration system of the loudspeaker in an axial direction of the loudspeaker,
wherein the loudspeaker includes a first voice coil and a second voice coil that, when viewed in a radial direction of the loudspeaker, are situated in a gap in which a magnetic flux propagates in the radial direction,
wherein a size of a range of the first voice coil in the axial direction of the loudspeaker is greater than a size of a range of the gap in the axial direction, and a size of a range of the second voice coil in the axial direction is less than the size of the range of the first voice coil in the axial direction,
wherein the range of the second voice coil in the axial direction falls within the range of the first voice coil in the axial direction, and
wherein the processor functions as:
a first driver configured to apply an audio signal amplified at a first amplification factor, which is set, to the first voice coil; and
a second driver configured to apply an audio signal amplified at a second amplification factor, which is set, to the second voice coil,
wherein when a position of the second voice coil in the axial direction represented by the displacement detected by the sensor is at a position at which the second voice coil is unable to interact with the magnetic flux propagating in the gap, the processor: sets an amplification factor that is smaller than when the position is at a position at which the second voice coil is able to interact with the magnetic flux, as the second amplification factor; and sets an amplification factor that is greater than when the position is at a position at which the second voice coil is able to interact with the magnetic flux, as the first amplification factor.

6. The acoustic system according to claim 1,
wherein the processor maneuvers the audio signal for driving the first voice coil such that the loudspeaker is excluded from causing an operation failure, based on the displacement detected by the sensor.
